(19) United States
(12) Patent Application Publication
(10) Pub. No.: US 2009/0021930 A1
(43) Pub. Date: Jan. 22, 2009

(54) Flexible multicolor light-emitting assembly

(76) Inventor: Ya-Fang Lee, Bang-Chiao City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/889,084

(22) Filed: Aug. 9, 2007

(30) Foreign Application Priority Data
Jul. 17, 2007 (TW) 096211597

(51) Int. Cl. F21V 9/08

(52) U.S. Cl. 362/231

(57) ABSTRACT

A flexible multicolor light-emitting assembly including at least three flexible conductive carriers and multiple multicolor light-emitting diodes connected between the flexible conductive carriers. The flexible conductive carriers can be freely flexed and bent as necessary. Therefore, the multicolor light-emitting diodes can be arranged in various patterns such as some characters or figures. Also, the flexible conductive carriers with the multicolor light-emitting diodes can be wound around or attached to an article such as a clothes, a sign, etc. After powered on, the multicolor light-emitting diodes are energized and lighted up to emit colorful light at the same time (in a sparkling state) or at different times (as a circular light).

### BACKGROUND OF THE INVENTION

1. Field of the Invention

The present invention is related to a flexible multicolor light-emitting assembly including multiple multicolor light-emitting diodes connected between more than two flexible conductive carriers. The flexible conductive carriers can be freely flexed and bent as necessary. Therefore, the multicolor light-emitting diodes can be arranged in various patterns such as some characters or figures. Also, the flexible conductive carriers with the multicolor light-emitting diodes can be wound around or attached to an article such as a clothes, a sign, etc. After powered on, the multicolor light-emitting diodes are lighted up to emit colorful light.

2. Description of the Prior Art

In general, light-emitting diodes are inlaid in a printed circuit board and driven and lighted up by the printed circuit of the circuit board. The light-emitting diodes are applicable to decorations, advertisement signs, etc. However, the printed circuit board is a rigid body and it is impossible to freely bend such circuit board as necessary. As a result, the light-emitting diodes are arranged in a fixed pattern and a user can hardly change the arrangement of the light-emitting diodes.

In addition, most of the current light-emitting diodes are monocolor light-emitting diodes. Therefore, after lighted up, such light-emitting diodes can only emit light of one color. As a result, the decorations or signs with such light-emitting diodes are monotonous and the application range of such light-emitting diodes is quite narrow.

### SUMMARY OF THE INVENTION

It is therefore a primary object of the present invention to provide a flexible multicolor light-emitting assembly including multiple multicolor light-emitting diodes connected between more than two flexible conductive carriers. The flexible conductive carriers can be freely flexed and bent as necessary. Therefore, the multicolor light-emitting diodes can be arranged in various patterns such as some characters or figures. Also, the flexible conductive carriers with the multicolor light-emitting diodes can be wound around or attached to an article such as a clothes, a sign, etc. After powered on, the multicolor light-emitting diodes are lighted up to emit colorful light at the same time (in a sparkling state) or at different times (as a circular light).

The present invention can be best understood through the following description and accompanying drawings wherein:

### BRIEF DESCRIPTION OF THE DRAWINGS

FIG. 1 is a perspective view of a first embodiment of the present invention;

FIG. 2 is a circuit diagram according to FIG. 1;

FIG. 3 is a perspective view of a second embodiment of the present invention;

FIG. 4 is a circuit diagram according to FIG. 3;

FIG. 5 is a circuit diagram of a third embodiment of the present invention;

FIG. 6 is a circuit diagram of a fourth embodiment of the present invention;

FIG. 7 is a circuit diagram of a fifth embodiment of the present invention; and

FIG. 8 is a circuit diagram of a sixth embodiment of the present invention.

### DETAILED DESCRIPTION OF THE PREFERRED EMBODIMENTS

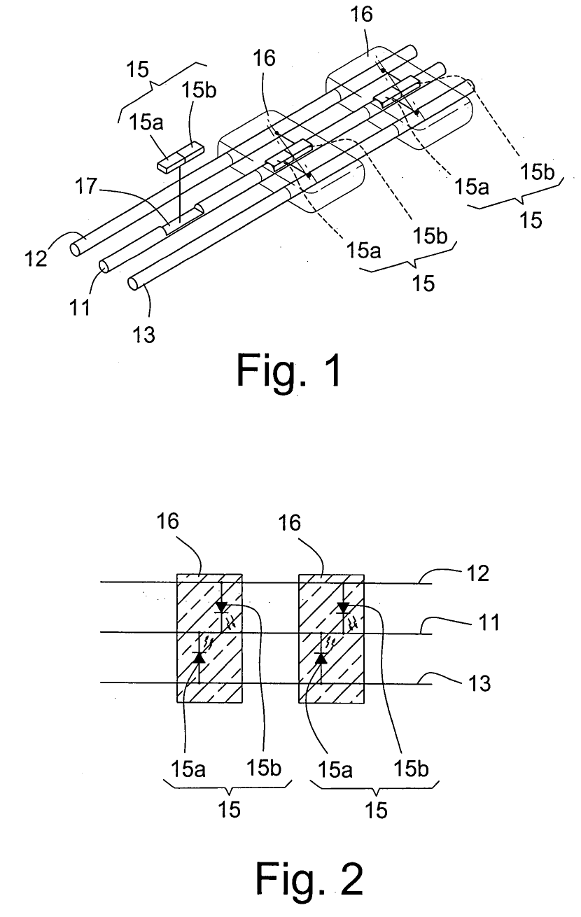

Please refer to FIGS. 1 and 2. The flexible multicolor light-emitting assembly of the present invention includes three strips of flexible conductive carriers 11, 12, 13 and a plurality of multicolor light-emitting diodes 15. Multiple light-emitting crystal grains 15a, 15b are packaged in each multicolor light-emitting diode 15. The common pins of the light-emitting crystal grains 15a, 15b are connected to one flexible conductive carrier 11, while the other pins of the light-emitting crystal grains 15a, 15b are respectively connected to the other two flexible conductive carriers 12, 13. The light-emitting crystal grains 15a, 15b together with the carriers 11, 12, 13 are packaged with a plastic body 16. Accordingly, the multicolor light-emitting diodes 15 and the flexible conductive carriers 11, 12, 13 are tightly fixedly associated. The flexible conductive carriers 11, 12, 13 can be freely flexed and bent as necessary, whereby the multicolor light-emitting diodes 15 can be arranged in various patterns such as some characters or figures. Alternatively, the flexible conductive carriers 11, 12, 13 with the multicolor light-emitting diodes 15 can be wound around or attached to an article such as a clothes or a sign. After powered on, the light-emitting crystal grains 15a, 15b of the multicolor light-emitting diodes 15 are energized to emit colorful light.

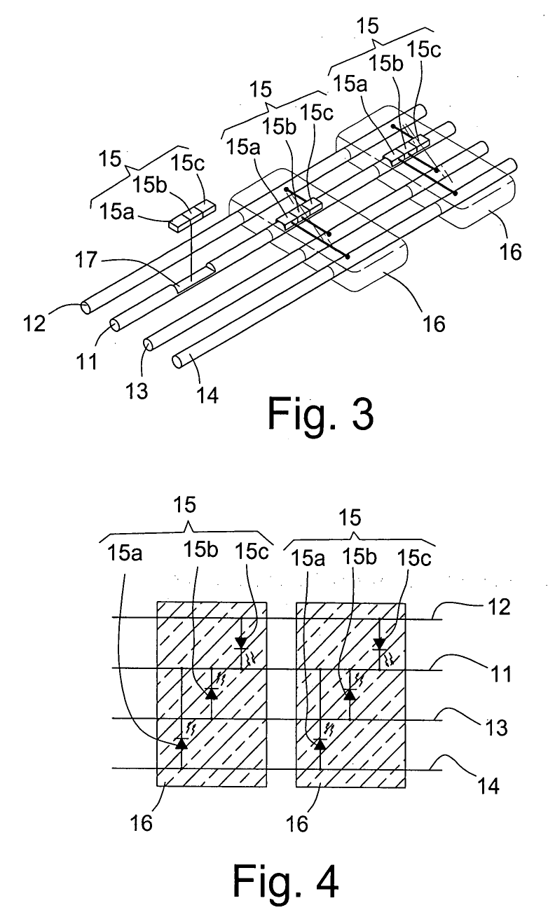

Referring to FIGS. 3 and 4, according to another embodiment, the flexible multicolor light-emitting assembly of the present invention includes four flexible conductive carriers 11, 12, 13, 14 and a plurality of multicolor light-emitting diodes 15. Three light-emitting crystal grains 15a, 15b, 15c are packaged in each multicolor light-emitting diode 15. The common pins of the light-emitting crystal grains 15a, 15b, 15c are connected to one flexible conductive carrier 11, while the other pins of the light-emitting crystal grains 15a, 15b, 15c are respectively connected to the other three flexible conductive carriers 12, 13, 14. The light-emitting crystal grains 15a, 15b, 15c together with the carriers 11, 12, 13, 14 are packaged with a plastic body 16. Accordingly, the multicolor light-emitting diodes 15 and the flexible conductive carriers 11, 12, 13, 14 are tightly fixedly associated. After the multicolor light-emitting diodes 15 are powered on, the light-emitting crystal grains 15a, 15b, 15c of the multicolor light-emitting diodes 15 are energized to respectively emit red light, green light and blue light. By means of modulating the brightness of the light emitted from the light-emitting crystal grains 15a, 15b, 15c, the multicolor light-emitting diodes 15 can emit colorful light including yellow light, orange light, purple light, white light, etc.

Referring to FIGS. 1 and 3, the common pins of the light-emitting crystal grains 15a, 15b, 15c of the multicolor light-emitting diodes 15 are connected to the flexible conductive carrier 11 with a cathode. The anode pins of the light-emitting crystal grains 15a, 15b, 15c are respectively connected to the flexible conductive carriers 12, 13, 14 with anodes.

In the flexible multicolor light-emitting assembly of the present invention, the multicolor light-emitting diodes 15 are lighted up on the flexible conductive carriers 11, 12, 13, 14 at the same time (in a sparkling state) or at different times (as a circular light).

In the flexible multicolor light-emitting assembly of the present invention, the flexible conductive carriers 11, 12, 13, 14 are strip-shaped or tape-shaped.

The flexible conductive carriers 11, 12, 13, 14 with the multicolor light-emitting diodes 15 can be wound around or laid on an article such as a clothes, a bracelet, a traffic sign, an advertisement sign, etc. After powered on, the multicolor light-emitting diodes 15 will emit colorful light to highlight the article and achieve a beautifying effect, a warning effect, an indicating effect, etc.

The flexible conductive carriers 11, 12, 13, 14 can be electric wires, soft circuit boards, metal wires, etc. This is not limited.

Referring to FIGS. 1 and 3, at least one of the flexible conductive carriers 11, 12, 13, 14 is formed with multiple plane platforms 17 on which the multicolor light-emitting diodes 15 are stably rested. Also, the common pins of the light-emitting crystal grains 15a, 15b, 15c of the multicolor light-emitting diodes 15 are connected to the platforms. The platforms 17 can be formed by means of pressing, punching, milling, chemical processing or the like.

Each the multicolor light-emitting diode 15 of the present invention contains more than two kinds of light-emitting crystal grains 15a, 15b, 15c which can emit different colors of light. The light-emitting crystal grains 15a, 15b, 15c are packaged into one piece which can be a rectangular solid body, a cylindrical body or the like.

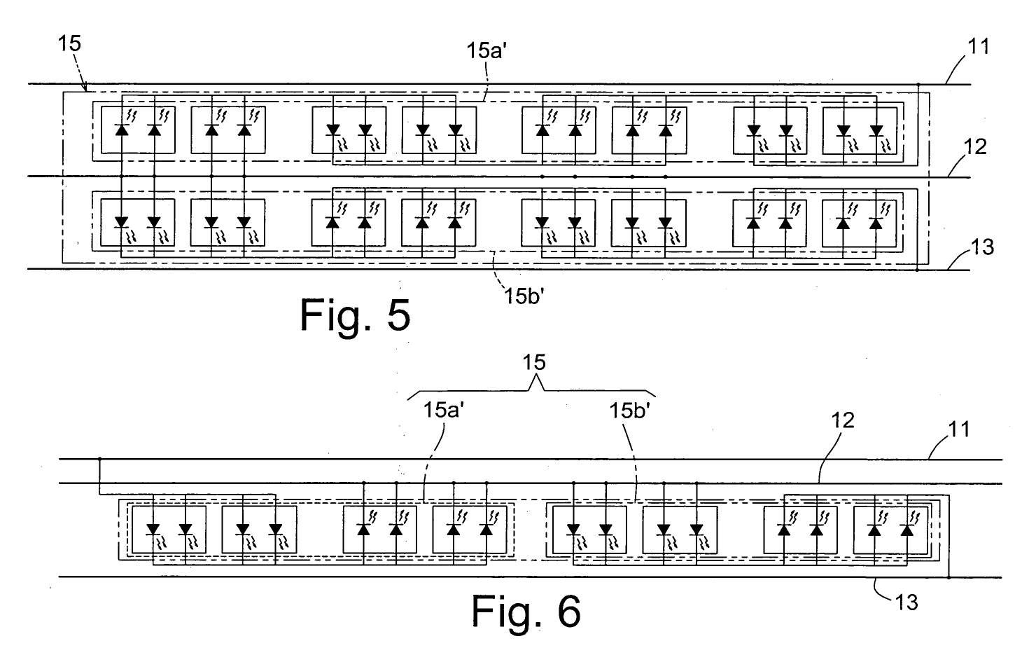

Referring to FIG. 5, according to still another embodiment of the present invention, each the multicolor light-emitting diode 15 contains two light-emitting crystal grain groups 15a′, 15b′ each of which is composed of multiple light-emitting crystal grains. One light-emitting crystal grain group 15a′ is connected from the second-priority flexible conductive carrier 12 to the first-priority flexible conductive carrier 11, while the other light-emitting crystal grain group 15b′ is connected from the second-priority flexible conductive carrier 12 to the third-priority flexible conductive carrier 13.

Referring to FIG. 6, according to still another embodiment of the present invention, each the multicolor light-emitting diode 15 contains two light-emitting crystal grain groups 15a′, 15b′ each of which is composed of multiple light-emitting crystal grains. One light-emitting crystal grain group 15a′ is connected from the first-priority flexible conductive carrier 11 to the second-priority flexible conductive carrier 12, while the other light-emitting crystal grain group 15b′ is connected from the second-priority flexible conductive carrier 12 to the third-priority flexible conductive carrier 13.

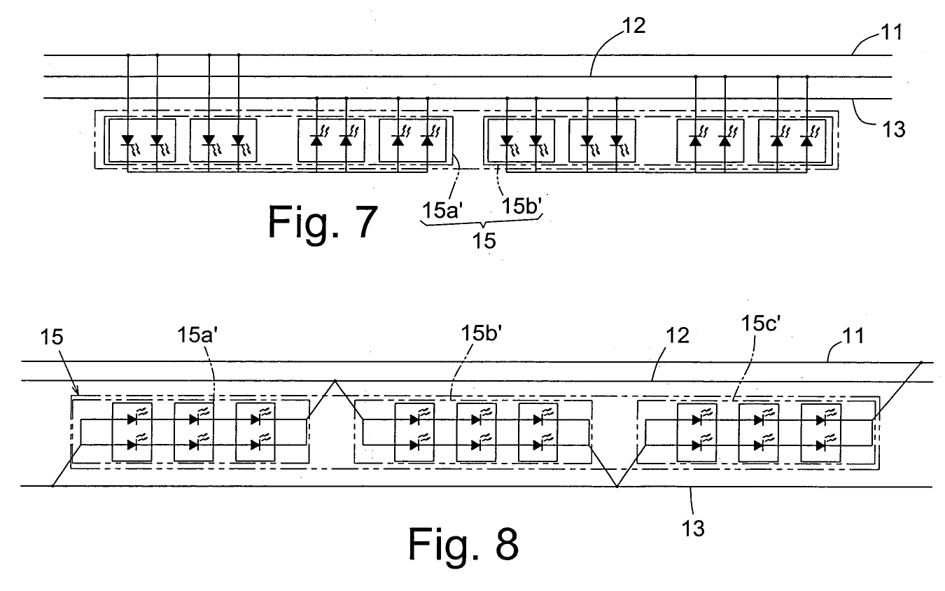

Referring to FIG. 7, according to still another embodiment of the present invention, each the multicolor light-emitting diode 15 contains two light-emitting crystal grain groups 15a′, 15b′ each of which is composed of multiple light-emitting crystal grains. One light-emitting crystal grain group 15a′ is connected from the first-priority flexible conductive carrier 11 to the third-priority flexible conductive carrier 13, while the other light-emitting crystal grain group 15b′ is connected from the third-priority flexible conductive carrier 13 to the second-priority flexible conductive carrier 12.

Referring to FIG. 8, according to still another embodiment of the present invention, each the multicolor light-emitting diode 15 contains three light-emitting crystal grain groups 15a′, 15b′, 15c′ each of which is composed of multiple light-emitting crystal grains. The first light-emitting crystal grain group 15a′ is connected from the third-priority flexible conductive carrier 13 to the second-priority flexible conductive carrier 12, the second light-emitting crystal grain group 15b′ is connected from the second-priority flexible conductive carrier 12 to the third-priority flexible conductive carrier 13, while the last light-emitting crystal grain group 15c′ is connected from the third-priority flexible conductive carrier 13 to the first-priority flexible conductive carrier 11. After the multicolor light-emitting diodes 15 are powered on, the light-emitting crystal grain groups 15a′, 15b′, 15c′ of the multicolor light-emitting diodes 15 are energized to emit red light, yellow light, green light, white light, etc.

According to the above arrangement, the multicolor light-emitting diodes 15 of the present invention are bridged between the flexible conductive carriers 11, 12, 13, 14. The flexible conductive carriers 11, 12, 13, 14 can be freely flexed and bent as necessary, whereby the multicolor light-emitting diodes 15 can be arranged in various patterns such as some characters or figures. Alternatively, the flexible conductive carriers 11, 12, 13, 14 with the multicolor light-emitting diodes 15 can be wound around or attached to an article such as a clothes, a sign, etc. After powered on, the multicolor light-emitting diodes 15 are lighted up at the same time or at different times to emit colorful light. This can achieve a beautifying/decorative effect, a warning effect, an indicating effect, etc.

The above embodiments are only used to illustrate the present invention, not intended to limit the scope thereof. Many modifications of the above embodiments can be made without departing from the spirit of the present invention.

What is claimed is:

1. A flexible multicolor light-emitting assembly comprising:
(a) at least three strips of flexible conductive carriers; and
(b) a plurality of multicolor light-emitting diodes, multiple light-emitting crystal grains being packaged in each multicolor light-emitting diode, the common pins of the light-emitting crystal grains being connected to one flexible conductive carrier, while the other pins of the light-emitting crystal grains being respectively connected to the other flexible conductive carriers, the light-emitting crystal grains together with the carriers being packaged with a plastic body, whereby the multicolor light-emitting diodes and the flexible conductive carriers are tightly fixedly associated.

2. The flexible multicolor light-emitting assembly as claimed in claim 1, wherein the multicolor light-emitting diodes are lighted up at the same time.

3. The flexible multicolor light-emitting assembly as claimed in claim 1, wherein the multicolor light-emitting diodes are lighted up at different times.

4. The flexible multicolor light-emitting assembly as claimed in claim 1, wherein the common pins of the light-emitting crystal grains of the multicolor light-emitting diodes are connected to one flexible conductive carrier with a cathode, while the anode pins of the light-emitting crystal grains are respectively connected to the flexible conductive carriers with anodes.

5. The flexible multicolor light-emitting assembly as claimed in claim 1, wherein at least one of the flexible conductive carriers is formed with multiple plane platforms.

6. The flexible multicolor light-emitting assembly as claimed in claim 1, wherein each of the multicolor light-emitting diodes contains two light-emitting crystal grain groups each of which is composed of multiple light-emitting crystal grains, one light-emitting crystal grain group being connected from a second-priority flexible conductive carrier to a first-priority flexible conductive carrier, while the other light-emitting crystal grain group being connected from the second-priority flexible conductive carrier to a third-priority flexible conductive carrier.

7. The flexible multicolor light-emitting assembly as claimed in claim 1, wherein each of the multicolor light-emitting diodes contains two light-emitting crystal grain groups each of which is composed of multiple light-emitting crystal grains, one light-emitting crystal grain group being connected from a first-priority flexible conductive carrier to a second-priority flexible conductive carrier, while the other light-emitting crystal grain group being connected from the second-priority flexible conductive carrier to a third-priority flexible conductive carrier.

8. The flexible multicolor light-emitting assembly as claimed in claim 1, wherein each of the multicolor light-emitting diodes contains two light-emitting crystal grain groups each of which is composed of multiple light-emitting crystal grains, one light-emitting crystal grain group being connected from a first-priority flexible conductive carrier to a third-priority flexible conductive carrier, while the other light-emitting crystal grain group being connected from the third-priority flexible conductive carrier to a second-priority flexible conductive carrier.

9. The flexible multicolor light-emitting assembly as claimed in claim 1, wherein each of the multicolor light-emitting diode contains three light-emitting crystal grain groups each of which is composed of multiple light-emitting crystal grains, a first light-emitting crystal grain group being connected from a third-priority flexible conductive carrier to a second-priority flexible conductive carrier, a second light-emitting crystal grain group being connected from the second-priority flexible conductive carrier to the third-priority flexible conductive carrier, while a last light-emitting crystal grain group being connected from the third-priority flexible conductive carrier to a first-priority flexible conductive carrier.
